(19) United States
(12) Patent Application Publication
(10) Pub. No.: US 2018/0148384 A1
(43) Pub. Date: May 31, 2018

(54) SULPHUR-BASED FERTILIZER COMPOSITION WITH LOW ROCK PHOSPHATE CONTENT

(71) Applicant: Tiger-Sul (Canada) Co., Halifax (CA)

(72) Inventors: Drew P. TAYLOR, Gilmanton, NH (US); Guy Wesley HAUN, West Liberty, OH (US)

(21) Appl. No.: 15/884,490

(22) Filed: Jan. 31, 2018

Related U.S. Application Data
(63) Continuation of application No. 13/761,788, filed on Feb. 7, 2013.

(51) Int. Cl. C05B 17/00; C05B 17/02; C05D 9/00

(52) U.S. Cl. CPC C05B 17/00; C05D 9/00; C05B 17/02

(57) ABSTRACT

A fertilizer composition is provided that includes sulphur and rock phosphate. The fertilizer composition can be a controlled release fertilizer that includes elemental sulphur, a rock phosphate, and a swelling material. The rock phosphate is present in the fertilizer composition in low amounts, e.g., 5% by weight or less. The fertilizer composition can be produced by mixing molten elemental sulphur with rock phosphate and cooling the mixture.

### TECHNICAL FIELD

The present disclosure is generally related to fertilizer compositions containing rock phosphate and elemental sulphur, and methods of making the same. More specifically, some aspects of this disclosure are directed to controlled release fertilizer compositions that contain elemental sulphur, rock phosphate, and a swelling material.

### BACKGROUND

In the agriculture industry, fertilizers are used to provide nutrients to plants that are typically delivered to the plants through the soil. Fertilizers can be added to soil in granular or pastille form, for example, which are beneficial from the perspective of storage and dissemination capabilities.

Sulphur is an essential plant nutrient that has been included in fertilizer compositions to improve crop performance and is considered to be a secondary nutrient.

Phosphorus is an essential plant macronutrient and has been included in large amounts in fertilizers to improve crop performance. Some fertilizers incorporate phosphate by using diammonium phosphate (DAP) and monoammonium phosphate (MAP). Such fertilizers generally cannot be used on crops that are certified as organic because the ammonium phosphate component is treated with acids. U.S. Patent No. 4,547,213 discloses the use of rock phosphate in fertilizer compositions in relatively large amounts to supply sufficient phosphate nutrient to the soil.

### SUMMARY

Before sulphur can be used by a plant, the elemental sulphur must be converted to sulphate by microorganisms that are present in the soil. During this process, the sulphur can decrease the pH or acidify soil because sulphuric acid is formed. Rock phosphate is insoluble in water and must be solubilized before the phosphorus is useable. When rock phosphate is present with elemental sulphur, the breakdown of elemental sulphur by microorganisms can acidulate the rock phosphate and convert the phosphorus into a plant available phosphate form. The inventors have discovered that acidulating the rock phosphate can further enhance the activity of the microorganisms in converting the elemental sulphur into plant-useable sulphate form. As such, a fertilizer composition combining elemental sulphur with relatively small amounts of rock phosphate can provide synergistic effects with respect to the availability of plant-useable sulphate.

Furthermore, in addition to the above, elemental sulphur-based fertilizers with rock phosphate can be used on crops that are certified as organic because neither elemental sulphur nor rock phosphate is treated with an acid in a manufacturing process.

In one aspect, this disclosure relates to both organic and inorganic fertilizer compositions that include at least 50% by weight of elemental sulphur; and 0.01% to 5% by weight of rock phosphate. In another aspect, this disclosure relates to a method of manufacturing a fertilizer composition containing sulphur and rock phosphate, the method including mixing molten elemental sulphur and rock phosphate, wherein the rock phosphate comprises from 0.1% to 5% by weight of the mixture; and cooling the mixture to obtain the fertilizer composition.

### BRIEF DESCRIPTION OF THE DRAWINGS

FIG. 1 is a schematic diagram illustrating an exemplary process for producing a fertilizer composition; and

FIG. 2 is a schematic diagram illustrating an exemplary process for producing fertilizer pastilles with a rotoformer machine.

### DETAILED DESCRIPTION OF THE EMBODIMENTS

The fertilizer composition described herein includes elemental sulphur and small amounts (e.g., 5% by weight or less) of rock phosphate.

One advantage of including sulphur and small amounts of rock phosphate in a fertilizer composition is that the acidulation of the rock phosphate can aid in the microbial breakdown of sulphur into plant-available sulphate. Thus, the rate of availability of sulphate from, for example, a controlled release fertilizer can be increased. Furthermore, incorporating only a small amount of rock phosphate into a sulphur-containing fertilizer can facilitate more precise soil management because the amount of plant-available sulphur in the soil can be more easily regulated without significantly affecting the amount of phosphorus in the soil.

The sulphur component can be provided as elemental sulphur. As discussed in connection with the production of fertilizer pastilles below, elemental sulphur can be provided in molten form and mixed with the other fertilizer components. The elemental sulphur can be at least about 95%, at least about 99% or at least about 99.5% pure.

The sulphur can constitute the bulk of the fertilizer composition (i.e., at least about 50% by weight) and can form the matrix of the fertilizer in which the other components are distributed. In some aspects, the sulphur can be present in the fertilizer composition in an amount of from about 40% to about 95% by weight, from about 60% to about 90% by weight, from about 70% to about 95% by weight, or from about 80% to about 90% by weight, based on the weight of elemental sulphur. As used herein, the term “about” will be understood to broaden the ranges somewhat to include values that may be attributable to known errors in measurement, compounding the fertilizer composition, or expected variations in raw material compositions.

Rock phosphate (also called phosphate rock or phosphorite) is typically a nondetrial sedimentary rock which contains high amounts of phosphate bearing minerals. The phosphate or phosphorus content of the rock phosphate of the present disclosure is not particularly limited. Typically, the phosphate content of rock phosphate is at least about 15%. However, in some sources of rock phosphate, the phosphate content of the rock can exceed levels of about 20% or even up to about 75% phosphate by weight. Accordingly, the amount of phosphate in the rock phosphate can be from about 15% to about 75% by weight, about 20% to about 65% by weight, about 20% to about 35% by weight, or about 35% to 50% by weight. The rock phosphate can have a total phosphorus content, i.e., as P₂O₅ measured by AOAC 2.3.02 (Official Methods Of Analysis Of AOAC International, 17^{th} Ed. 1998), of about 5% to about 50%, about 10% to about 40%, or about 20% to about 30%. The rock phosphate can have an available phosphorus content, i.e., as P₂O₅ measured by AOAC 2.3.14, of from about 0.5% to about 20%, from about 1% to about 10%, or from about 2% to about 6%.

The phosphate content of the rock phosphate can be present in various forms, including but not limited to apatites, such as fluorapatite (Ca₅(PO₄)₃F), hydroxyapatite (Ca₅(PO₄)₃OH), and chlorapatite (Ca₅(PO₄)₃Cl), and chemically dissolved phosphate minerals, for example, from igneous rocks and metamorphic rocks.

The rock phosphate of the present disclosure can be any type of rock phosphate. Some general forms of rock phosphate can include various limestones and mudstones, which are common phosphate bearing rocks. Sedimentary phosphate rocks can commonly be found on the ocean floor and near shales, cherts, limestone, dolomites, and in some cases sandstones. The rock phosphate can also include peloids, oolites, fossils, and clasts that comprise apatite.

Some forms of rock phosphate can be dried and/or calcined. Calcination can typically occur at temperatures of about 1,480° F. to about 1,520° F. Alternatively, depending on the source of the rock phosphate, organics may be present and the rock phosphate can, in some cases, be heated to temperatures of about 1,400° F. to about 1,600° F. to remove the organic material.

The fertilizer composition provided by this disclosure can include rock phosphate in an amount from. about 0.01% to about 5% by weight, based on the amount of rock phosphate added to the fertilizer composition, and in some embodiments can include an amount from about 0.05% to about 2%, from about 0.1% to about 1.0%, and from about 0.25% to about 0.5% by weight of the rock phosphate. Because the phosphorus content of the rock phosphate is less than 100%, the content of elemental phosphorus in the fertilizer composition is lower than the aforementioned ranges.

Based on these relatively low concentrations of rock phosphate, the amount of phosphorus that will be available as a plant nutrient from the fertilizer composition will be very low. Indeed, under the regulations of many jurisdictions the available phosphate content may be below the threshold limit required for the fertilizer to be labeled as a phosphate-containing fertilizer. However, as indicated above, the low concentrations of rock phosphate are included in the fertilizer composition to enhance the activity of the microorganisms in the soil to break down elemental sulphur to sulphate. In this regard, it was surprisingly found that small quantities of the rock phosphate can significantly enhance sulphate availability as discussed herein.

The rock phosphate is preferably substantially uniformly incorporated in the fertilizer composition, e.g., it can be dispersed substantially uniformly in the sulphur matrix such that there is no more than a 10% variation of rock phosphate content in samplings (e.g., samplings of 5 mg could vary from 4.75 mg to 5.25 mg). Desired uniformity can be achieved by ensuring sufficient mixing of the fertilizer components and by using rock phosphate having a sufficiently fine average particle size. Substantial uniform distribution can provide a more predictable increased controlled release of plant soluble sulphate from the fertilizer.

The raw material rock phosphate is ground before being mixed with the elemental sulphur component of the fertilizer composition. Mined rock phosphate can be slurried in water and wet-ground in ball mills or rod mills. The slurry can then be dried in direct-fired dryers at about 250° F. where the moisture content of the rock can fall from about 10 to about 15 percent to about 1 to about 3 percent. The rock phosphate raw material can be ground to a very fine mesh particle size (about 270-mesh) in roll or ball mills. In some embodiments, the rock phosphate can have a particle diameter of less than about 100 microns (μm) (where at least 85% of the particles have this size), and preferably less than about 75pm and less than about 55 μm.

Controlled release fertilizer compositions release plant nutrients in controlled amounts over time when the composition is wetted. As the term is used herein, “controlled release” is intended to refer to the gradual release of the sulphur component from the fertilizer composition and does not necessarily refer to the phosphate component from the rock phosphate. The phosphate may or may not be released at controlled rates. The controlled release compositions are typically provided in granule, pellet, pastille, or particulate form. The fertilizer composition can be, in one embodiment, generally spherical, or in another embodiment, can be a generally pastille form. The spherical or pastille form of granulated fertilizer particles can help to reduce the generation of fines due to abrasive inter particle interaction which, in turn, reduces the amount of such fines being rendered airborne as dust, increasing the amount of fertilizer ultimately deposited on specific piece of soil while simultaneously reducing waste. Some embodiments can include fertilizer pellets having a diameter of about 0.5 to about 4 mm, or about 1 to 3 mm, or about 2.5 mm.

The swelling material in the fertilizer composition expands when wetted. In pastille or pellet form (or similar), the expansion can allow moisture into the pastille and can break the sulphur into smaller particles, which allows microorganisms that are present in the soil to convert the sulphur into the plant-useable sulphate form. The sulphate form is released into the soil where it can be used by plants. When the elemental sulphur is formulated with swelling clay, the bulking properties of the sulphur, the controlled rate of its breakdown, and the release of any contained phosphate and micronutrients should be considered.

The swelling material can include a swelling clay, such as high swelling bentonite clay. One suitable bentonite clay product is CANAPRILL PLUS available from Canadian Clay Products (Wilcox, Saskatchewan) that has a 200 mesh particle size (85-95%). Another suitable bentonite swelling clay is available from Muldoon Minerals, Inc. (Muldoon, Tex.).

The swelling material can be present in the fertilizer in amounts of about 2% to about 30% by weight, from about 5% to about 25% by weight, from about 5% to about 15% by weight, and preferably from about 8% to about 12% by weight.

The fertilizer composition can also optionally include other plant nutrients including nitrogen, potassium, boron, iron, copper, zinc, manganese, magnesium or combinations of the foregoing. If boron is present, the fertilizer composition can include a boron containing compound as disclosed in application Ser. No. 13/657,550 filed on Oct. 22, 2012, entitled FERTILIZER COMPOSITION CONTAINING SULFUR AND BORON, by Drew Taylor, et al., which is incorporated herein by reference in its entirety, and discloses a controlled release fertilizer containing an anhydrous boron containing compound (e.g. anhydrous borax). The other plant nutrients can be present in the fertilizer composition in amounts of from about 0.25% to about 40% by weight, from about 0.5% to about 20% by weight, or from about 1% to about 5% by weight, based on elemental weight.

Exemplary controlled release rate fertilizers containing rock phosphate may be manufactured by mixing molten sulphur with ground rock phosphate. In some embodiments, the moisture content of the rock phosphate can be maintained or dried at a moisture content below 1 percent until just before mixing. Ensuring that the rock phosphate has a low moisture content prevents flashing or foaming during production. The molten sulphur can be first mixed with a swelling material, and in some embodiments, a swelling material and then the rock phosphate can be added to the mixture of molten sulphur and the swelling material. Alternatively, the rock phosphate can be first mixed with the molten sulphur and then the swelling material can be subsequently added.

The order of addition or mixing is not particularly limited. In some embodiments, a portion of the sulphur and all of the swelling material may be first mixed, then the rock phosphate can be added to the mixture of swelling material and sulphur, and then the remainder of the molten sulphur may be added to the mixture. In some embodiments, the swelling material and/or the rock phosphate can be heated prior to their addition to the mixture.

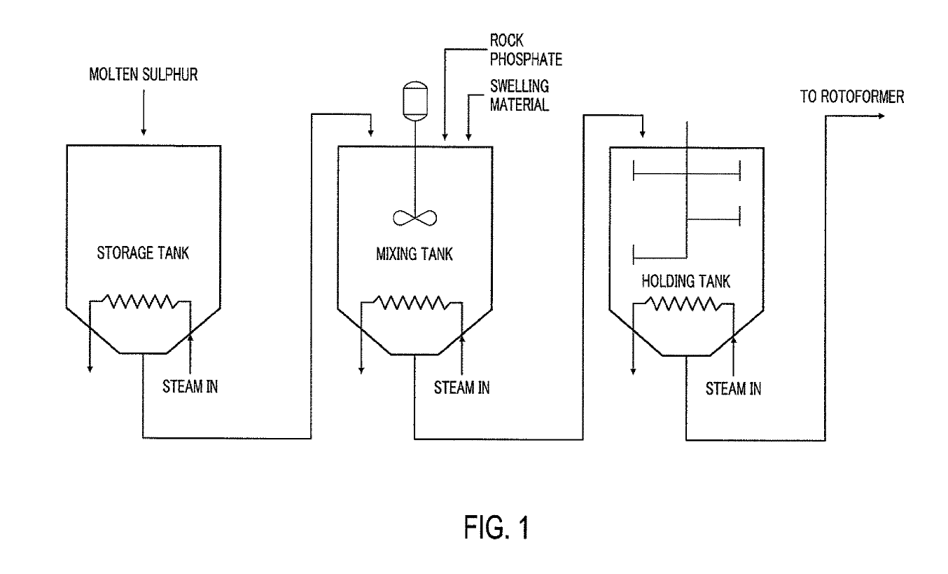

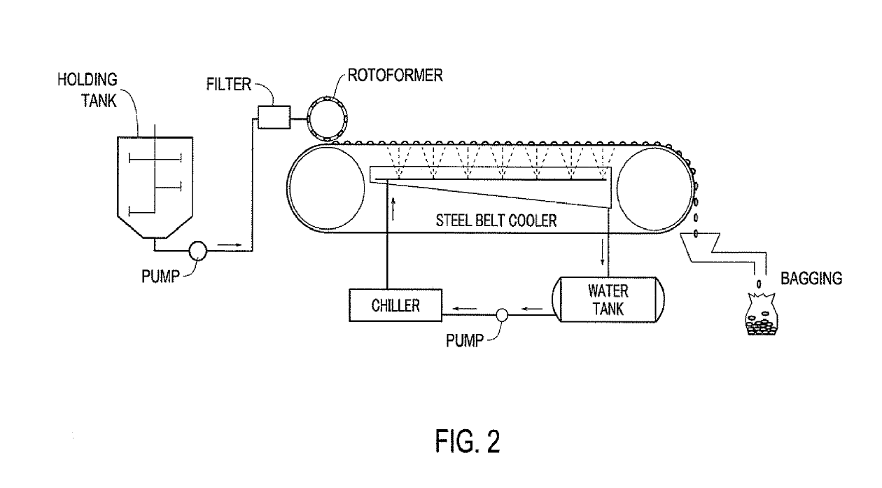

The fertilizer composition may be manufactured using a batch method or using a continuous flow method. The exemplary methods described in connection with FIGS. 1 and 2, discussed below, are not meant to limit the method of production to a particular method of manufacture.

FIG. 1 shows an exemplary process for manufacturing a controlled release rate fertilizer containing rock phosphate. Molten sulphur having a temperature of about 250° F. is added to a storage tank. Heat is then added to the storage system through a superheated steam line. In an alternative embodiment, non-molten sulphur can be heated to a molten state and then added to the storage tank.

The sulphur is then transported to a mixing tank. The molten sulphur can be pumped and metered into the mixing tank. The mixing tank then mixes the molten sulphur while the rock phosphate and swelling material are added. In one embodiment, the swelling clay, which can be bentonite clay, is added to the continuously stirred molten sulphur. Rock phosphate is then added to the mixture of molten sulphur and clay. The mixture is then allowed to mix in the mixing tank for sufficient time to create a substantially homogenous mixture. In one embodiment, the mixture can be mixed for about 1 minute to about 10 hours, from about 10 minutes to about 5 hours, from about 15 minutes to about 1 hour, or for about 30 minutes. Heat is added to the system to keep the temperature well above the melting point of sulphur, e.g., at about 270° F., during the mixing process.

After the mixing process is complete, the molten mixture can then be placed in a holding tank, tanker for shipping, or alternatively can be pelletized in a rotoformer. In one embodiment, the holding tank can also be stirred to ensure the molten mixture remains substantially homogenous. Additionally, as shown in FIG. 1, heat may be added to the holding tank, for example through a steam line. When needed, the molten mixture can then be transferred to a rotoformer.

FIG. 2 is a schematic diagram illustrating an exemplary process for producing fertilizer pastilles with a rotoformer. The molten mixture is pumped from the holding tank through a filter, which may be a 270-mesh sized filter, for example. The filter can alternatively be a 140-mesh, 230-mesh, 325-mesh or 400-mesh filter. The molten mixture is then pumped through a rotoformer onto a steel belt. After the molten mixture passes through the rotoformer onto the steel belt, the molten mixture is then cooled on the belt to form pastilles. In one embodiment, the steel belt can be additionally cooled by spraying cooled water on the undercarriage of the steel belt. The water can be recycled and chilled prior to use in the sprayers. The molten mixture can also be cooled by allowing the mixture to equilibrate with room temperature. After the pastilles sufficiently harden, they can be removed from the belt with a blade, and then either put into storage for bulk shipment or packaged in smaller bags for distribution.

### Analysis of Rock Phosphate-Containing Fertilizers

Laboratory research trials were conducted to evaluate the potential benefits of adding rock phosphate into sulphur-based controlled release fertilizers. The laboratory used for both Laboratory Trials was a member of the Canadian Association for Laboratory Accreditation and was International Organization for Standardization (ISO) 17025 certified.

Laboratory Trial 1

As discussed above, elemental sulphur must be converted into sulphate before it can be used by plants. This study was conducted to evaluate the amount of sulphate that is released from two sulphur-based fertilizer compositions containing rock phosphate over a twelve week period.

In this trial, a native soil sample without any added plant nutrients is used as the control, TIGER 90CR® (Tiger-Sul Products) is a granular degradable sulphur-based fertilizer (about 90% sulphur by weight and about 10% bentonite swelling clay by weight) that does not include any phosphate-containing component, Trial Fertilizer 1 is a granular degradable sulphur-based fertilizer containing about 90% sulphur, about 0.5% rock phosphate, and the remainder bentonite clay, and Trial Fertilizer 2 is a granular degradable sulphur-based fertilizer containing about 80.5% sulphur, about 0.25% rock phosphate, and the remainder bentonite clay.

The soil in each sample was inoculated with microorganisms that oxidize sulphur. 250 mg of each fertilizer composition was added to 200 g of soil at 24% saturation. Water was periodically passed through the soil and collected at the intervals shown in Table 1. The water was analyzed for sulphate content. The results are shown in Table 1.

TABLE 1
Rock Phosphate Influence on Sulphate (SO₄) Availability

| | Sulphate Released (mg/L) | | | | | |
|---|---|---|---|---|---|---|
| | Week 1 | Week 3 | Week 6 | Week 9 | Week 12 | Total |
| Control | 29.1 | 43.6 | 39.3 | 37.8 | 40.7 | 190.5 |
| Tiger 90CR ® | 89.6 | 333.3 | 497 | 959 | 1,315 | 3,193.9 |
| Trial Fertilizer 1 | 195.9 | 680 | 1,367 | 2,035 | 2,019 | 6,296.9 |
| Trial Fertilizer 2 | 267.3 | 793 | 1,441 | 1,922 | 2,330 | 6,753.3 |

As can be seen from Table 1, there is a significant synergistic effect between sulphur and rock phosphate in which the presence of a relatively small amount of rock phosphate in the fertilizer granule substantially increases the release of sulphate. For example, as compared to a comparable fertilizer product containing no rock phosphate (Tiger 90CR®), both Trial Fertilizer 1 and Trial Fertilizer 2, which had only 0.5% and 0.25% rock phosphate by weight respectively, exhibited significantly increased amounts of sulphate availability.

When compared to Tiger 90CR®, Trial Fertilizer I showed an increase of sulphate availability of about 118% in week 1, about 104% in week 3, about 175% in week 6, about 112% in week 9, and about 53% in week 12.

When compared to Tiger 90CR®, Trial Fertilizer 2 showed an increase in sulphate availability of about 198% in week 1, about 137% in week 3, about 189% in week 6, about 100% in week 9, and about 77% in week 12.

Thus, as can be seen in Table 1, a small amount of rock phosphate in the controlled release fertilizer had a significant increase in the amount of sulphate released over the twelve week period. The oxidation of sulphur into sulphate is typically accomplished through microorganisms in the soil, and it is therefore believed that the phosphorus that is released by the rock phosphate may enhance the ability of the microorgansims to break down the elemental sulphur.

Laboratory Trial 2

A second laboratory trial (see Table 2 below) was conducted to confirm the study conducted in Laboratory Trial 1. All three fertilizers (Tiger 90CR®, Trail Fertilizer 1, and Trial Fertilizer 2) have the same composition as the fertilizers used in Laboratory Trial 1.

Table 2 illustrates the results of the second laboratory trial in which the three fertilizers were compared. The second laboratory trial was done with native soil under the same controlled laboratory conditions as was done in the first study. In the second study, the amount of sulphate released was also measure five different times over a twelve week period.

TABLE 2
Rock Phosphate Influence on Sulphate (SO₄) Availability

| | Sulphate Released (mg/L) | | | | | |
|---|---|---|---|---|---|---|
| | Week 1 | Week 3 | Week 6 | Week 9 | Week 12 | Total |
| Control | 85.9 | 86.3 | 102 | 106 | 155 | 535.2 |
| Tiger 90CR ® | 138 | 395 | 525 | 713 | 926 | 2,697 |
| Trial Fertilizer 1 | 408 | 904 | 1194 | 1356 | 1335 | 6,368 |
| Trial Fertilizer 2 | 565 | 1132 | 1470 | 1516 | 1685 | 5,197 |

As can be seen in Table 2, the synergistic effect between sulphur and small concentrations of rock phosphate was confirmed. The fertilizers with about 0.5% and 0.25% rock phosphate by mass were able to significantly increase the rate of oxidation of sulphur to sulphate, increasing the amount of sulphate released from the controlled release fertilizer for the entire twelve week period.

When compared to Tiger 90CR®, Trial Fertilizer 1 showed an increase of sulphate availability of about 195% in week 1, about 128% in week 3, about 127% in week 6, about 90% in week 9, and about 44% in week 12.

When compared to Tiger 90CR®, Trial Fertilizer 2 showed an increase of sulphate availability of about 309% in week 1, about 186% in week 3, 180% in week 6, about 112% in week 9, and about 81% in week 12.

The Laboratory Trials discussed above demonstrate that there is a significant synergistic effect between sulphur and rock phosphate that should stimulate greater provision of plant nutrients to enhance both sulphate availability and crop productivity.

The controlled release rate fertilizers containing rock phosphate can be used to fertilize a field by dispersing the fertilizer composition throughout the field. As discussed above, in the fertilizer compositions described in this application, the phosphorus is generally present in amounts that are negligible to provide phosphorus as a plant macronutrient to crops. Thus, if desired, a second fertilizer composition can be dispersed in the soil, where the second fertilizer composition contains phosphorus in greater concentrations, e.g., in concentrations that are sufficient to supply phosphorus as a plant macronutrient.

While the invention has been described in conjunction with the specific exemplary embodiments thereof, it is evident that many alternatives, modifications, and variations will be apparent to those skilled in the art. Accordingly, exemplary embodiments of the invention as set forth herein are intended to be illustrative, not limiting. There are changes that may be made without departing from the spirit and scope of the invention.

What is claimed is:

1. A fertilizer composition comprising:
(i) at least 50% by weight of elemental sulphur; and
(ii) 0.01% to 5% by weight of rock phosphate.

2. The fertilizer composition of claim 1, further comprising a swelling material.

3. The fertilizer composition of claim 1, wherein the rock phosphate is present in an amount of 0.05% to 2% by weight.

4. The fertilizer composition of claim 1, wherein the rock phosphate is present in an amount of 0.1% to 1.0% by weight.

5. The fertilizer composition of claim 1, wherein the rock phosphate is present in an amount of about 0.25% to about 0.5% by weight.

6. The fertilizer composition of claim 1, wherein the fertilizer composition comprises at least 75% by weight of elemental sulphur.

7. The fertilizer composition of claim 1, wherein the fertilizer composition comprises 60% to 90% by weight of elemental sulphur.

8. The fertilizer composition of claim 2, wherein the fertilizer composition is a controlled release fertilizer composition.

9. The fertilizer composition of claim 8, wherein the fertilizer composition includes from 5% to 25% by weight of the swelling material.

10. The fertilizer composition of claim 8, wherein the fertilizer composition includes from 5% to 15% by weight of the swelling material.

11. The fertilizer composition of claim 2, wherein the swelling material is a swelling clay.

12. The fertilizer composition of claim 11, wherein the swelling clay is bentonite clay.

13. The fertilizer composition of claim 1, further comprising one or more additional nutrients selected from the group consisting of nitrogen, potassium, iron, copper, zinc, boron, manganese, and magnesium.

14. The fertilizer composition of claim 13, wherein the one or more additional nutrients is present in the fertilizer composition in an amount of from about 0.25% to about 40% by weight.

15. The fertilizer composition of claim 1, wherein the fertilizer composition is provided as one or more of a pellet, pastille, or granule.

16. The fertilizer composition of claim 1, wherein the rock phosphate contains at least 20% by weight of elemental phosphorus.

17. The fertilizer composition of claim 1, wherein the rock phosphate contains at least 50% by weight of elemental phosphorus.

18. A method of fertilizing plants comprising dispersing the fertilizer composition of claim 1 in soil.

19. The method of claim 18, further comprising dispersing a second fertilizer composition in the soil, wherein the second fertilizer composition contains phosphorus.

20. A method of manufacturing a fertilizer composition containing sulphur and rock phosphate, the method comprising:
mixing molten elemental sulphur and rock phosphate, wherein the rock phosphate comprises from 0.1% to 5% by weight of the mixture; and
cooling the mixture to obtain the fertilizer composition.

21. The method of claim 20, further comprising forming the composition into pastilles, pellets, or granules and then cooling the composition below the melting point of sulphur in the cooling step.

22. The method of claim 20 further comprising grinding the rock phosphate to have an average particle size of less than 55 μm prior to mixing it with the molten elemental sulphur.
